(19) United States
(12) Patent Application Publication
(10) Pub. No.: US 2011/0225634 A1
(43) Pub. Date: Sep. 15, 2011

(54) CAPTCHA (Completely Automated Public Test to Tell Computers and Humans Apart) Data Generation Methods and Related Data Management Systems and Computer Program Products Thereof

(75) Inventor: Helen Pai, Cupertino, CA (US)

(73) Assignee: F2WARE INC., Cupertino, CA (US)

(21) Appl. No.: 13/048,565

(22) Filed: Mar. 15, 2011

(30) Foreign Application Priority Data
Mar. 15, 2010 (TW) 99107419

(51) Int. Cl. H04L 9/32

(52) U.S. Cl. 726/6

(57) ABSTRACT

CAPTCHA (Completely Automated Public Test to tell Computers and Humans Apart) data generation methods for use in a server and related management systems are provided. First, the server determines a first data set according to at least one first data corresponding to an operation to be performed, wherein the first data represents a sensitive data corresponding to the operation. Then, the server generates a group of CAPTCHA data corresponding to the first data set according to the first data.

### CROSS REFERENCE TO RELATED APPLICATIONS

This Application claims priority of Taiwan Patent Application No. 099107419, filed on Mar. 15, 2010, the entirety of which is incorporated by reference herein.

### BACKGROUND OF THE INVENTION

1. Field of the Invention

The disclosure relates generally to data generation methods and related data generation systems, and, more particularly to data generation methods and related data generation systems for generating data based on CAPTCHA (Completely Automated Public Test to tell Computers and Humans Apart) data that provide enhanced data protection for transmitted data.

2. Description of the Related Art

With increasing growth and development in network applications, the opportunity for users to access information through a network has been significantly increased. A user may utilize various electronic devices, such as computer systems, portable devices and so on, to perform a large number of services and applications through the network. In some network services, a user may need to perform a registration procedure for specific service or perform a confirmation procedure regarding some information. In the registration or the confirmation process, the user has to inspect related information provided by the server that provides the specific service and inputs related data based on the provided information for the registration or confirmation procedure.

Conventionally, information transmitted between a client and a server is done by using computer-based texts, which may easily be revised by malicious programs, e.g. viruses or wooden horse programs. Even if a virtual keyboard is utilized for inputting, the data inputted at the client side is still transmitted to the server by using computer-based texts. For example, input of the current transaction data may be made by a keyboard or a virtual keyboard that appears on the computer screen. The data that is selected at the client side and transmitted to the server is transmitted by using computer-based texts for recognition of the transaction content.

To prevent personal data or content of operations from being tampered with or stolen by unauthorized users, enhancements in security strategies for data transmission between the server and the client are required. It is therefore desirable to provide a method and system capable of ensuring that data transmitted between the server and the client are correct and are being protected when any operation is performed between a server and a client.

### BRIEF SUMMARY OF THE INVENTION

Data generation methods and data generation systems thereof are provided.

In one exemplary embodiment, a data generation method for CAPTCHA (Completely Automated Public Test to tell Computers and Humans Apart) data generation for a server is provided. The method comprises determining a first data set according to at least one first data corresponding to an operation, wherein the first data represents a sensitive data corresponding to the operation, and generating a group of CAPTCHA data corresponding to the first data set according to the first data.

In another exemplary embodiment, a data generation system for CAPTCHA (Completely Automated Public Test to tell Computers and Humans Apart) data generation is provided. The system at least comprises a server determining a first data set according to at least one first data corresponding to an operation, and generating a group of CAPTCHA data corresponding to the first data set according to the first data, wherein the first data represents a sensitive data corresponding to the operation.

In another exemplary embodiment, a non-transitory machine-readable storage medium comprising a computer program, which, when executed, causes a device to perform a data generation method for CAPTCHA (Completely Automated Public Test to tell Computers and Humans Apart) data is provided. The computer program comprises a first program code for determining a first data set according to at least one first data corresponding to an operation, wherein the first data represents a sensitive data corresponding to the operation, a second program code for generating a group of CAPTCHA data corresponding to the first data set according to the first data, and a third program code for hiding corresponding encrypted data into each CAPTCHA data in the group of CAPTCHA data, wherein the encrypted data includes information corresponding to the operation.

### BRIEF DESCRIPTION OF THE DRAWINGS

The invention will become fully understood by referring to the following detailed description with reference to the accompanying drawings, wherein:

FIG. 1 is a schematic diagram illustrating an embodiment of a data generation system of the invention;

FIG. 2 is a schematic diagram illustrating an embodiment of CAPTCHA data of the invention;

FIG. 3 is a schematic diagram illustrating an embodiment of CAPTCHA data with encrypted data of the invention; and

FIG. 4 is a flowchart of an embodiment of a data generation method of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Embodiments of the invention provide data generation methods and related data generation systems for performing an operation based on CAPTCHA (Completely Automated Public Test to tell Computers and Humans Apart) data for a server, wherein the server may determine a first data set according to one or more sensitive or important data corresponding to an operation requested by a user at a client side. Then, the server generates a group of CAPTCHA data corresponding to the first data set according to the sensitive or important data. At the same time, a specific encrypted data (such as a watermark) may be added to every CAPTCHA data generated. After that, the group of CAPTCHA data with encrypted data may be used to perform an operation with the client and verify data transmitted between the client and the server. Hence preventing the data from being revised during the transmission process.

In the embodiments, a data generation method is provided to use the CAPTCHA data generated (e.g. images or pictures) for an operation (e.g. a transaction process). First, a server generates images (CAPTCHA data) that can be recognized by human users or computers, wherein the images generated may be in different arrangements or combinations according to contents of different transactions. Then, the server may transmit the image to a client via a transmission medium. The client may use the image as an input for transaction data so that transaction processes can be performed, and send the images to a server via a transmission medium. Finally, the server may verify content of the transaction according to the image.

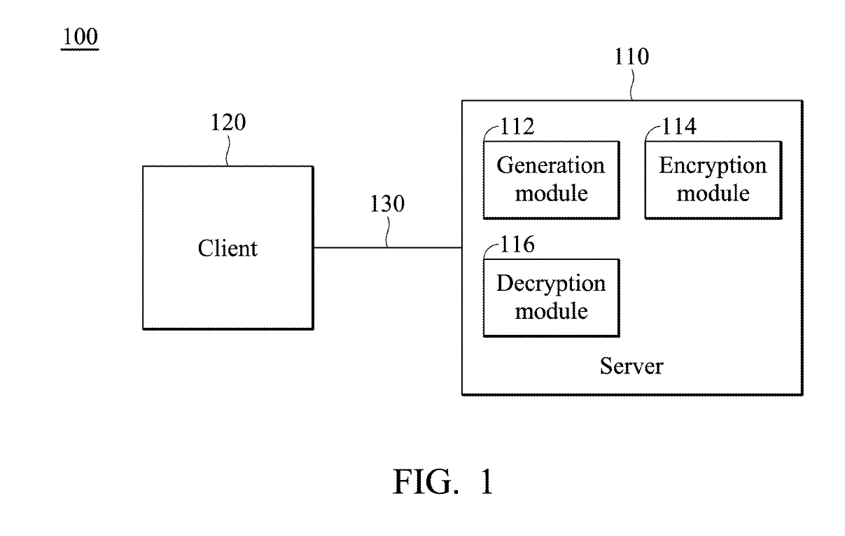

FIG. 1 is a schematic diagram illustrating an embodiment of a data generation system of the invention. The data processing system 100 at least comprises a server 110 and a client 120, wherein the server 110 may transmit data to the client 120 via a transmission medium, such as a network 130, for performing an operation between the server 110 and the client 120. The transmission medium may comprise, for example, and not limited to, the network 130, which may comprise wired or wireless networks, such as the INTERNET, but it is not limited thereto. In this embodiment, an operation may comprise one or more operational steps and the operational steps follow a predetermined execution flow. When the operation is performed, all of the operational steps corresponding thereto should be sequentially performed according to the predetermined execution flow.

The server 110 further comprises a generation module 112, an encryption module 114, and a decryption module 116. The generation module 112 is configured to determine a first data set according to a first data. Furthermore, the generation module 112 may determine a first data set according to one or more first data corresponding to an operation to be performed, wherein, the first data may be a sensitive data corresponding to the operation, such as user's personal identity information, account number, transaction amount, address and so on. The first data may require special processing since it may have an effect on the outcome of the operation. A first data set may comprise all possible information corresponding to a first data. For example, suppose the first data is a numeric data, the corresponding first data set may be the numbers 0-9.

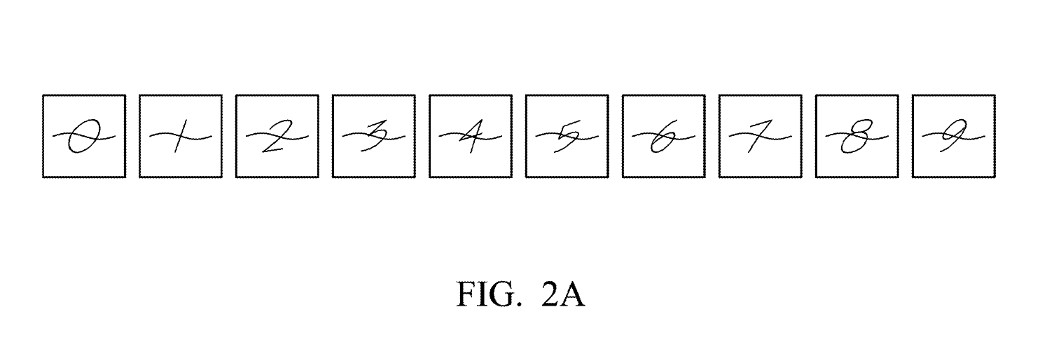

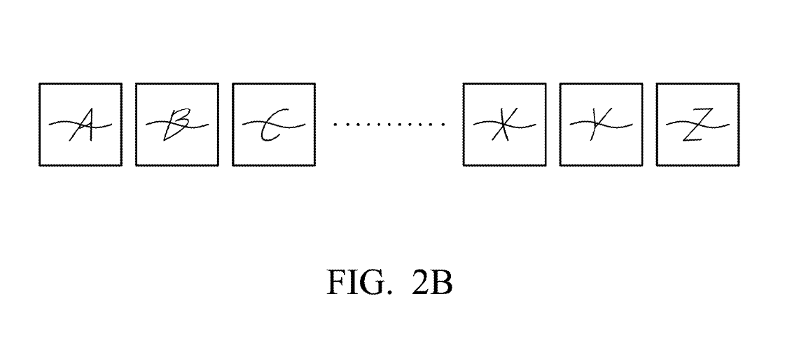

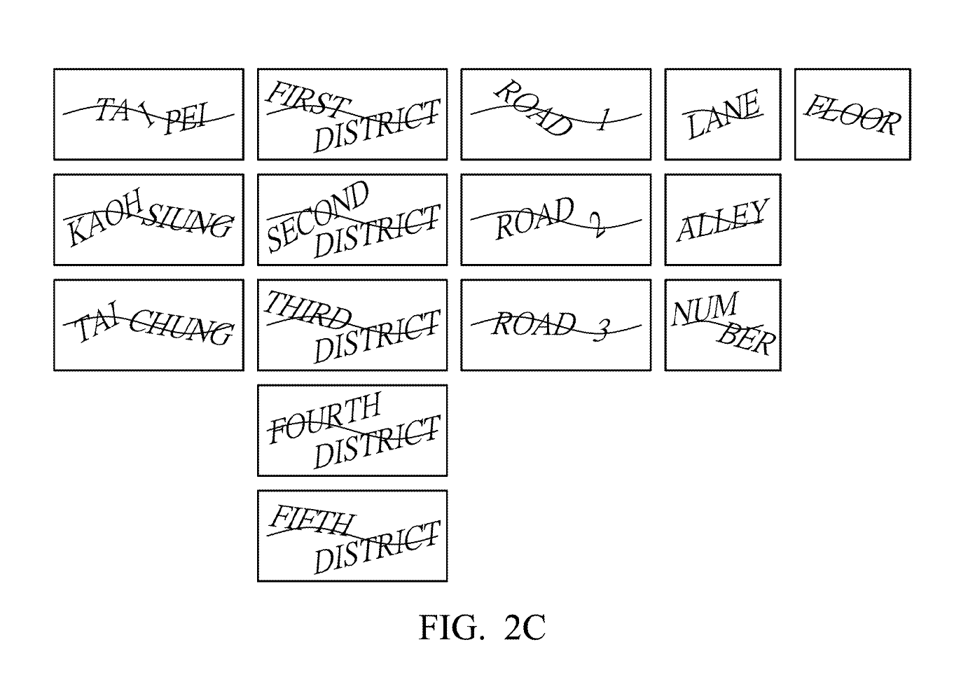

Then, according to a property of the first data, the generation module 112 may generate a group of CAPTCHA data corresponding to the first data set. In order to prevent input of a large number of malicious data and repeated data from automatic programs or computers, the CAPTCHA technique can be utilized to distinguish between a computer and a human user by identifying whether an input is made by a human user or generated by a computer automatically. Generally, the CAPTCHA process usually involves one computer asking a user to input letters or digits shown in a distorted image that other computers or automatic programs are supposedly unable to mimic, such as an image with skewed and/or deformed letters or digits or an image with letters or digits including a line added thereon, so as to distinguish between whether the input (response) is made by a human user or by a computer. It is to be noted that, in this embodiment, the concept of CAPTCHA is applied to provide CAPTCHA data corresponding to data required by the operation. The first data set may be divided into multiple data segments according to a property of the first data. For example, when the first data is a numeric data composed of one or more numbers, each data segment may be one or more numbers. Therefore, according to a property of numeric data, the generation module 112 may generate a group of CAPTCHA data comprising numbers 0-9 (as shown in FIG. 2A). In another embodiment, when the first data is a character data which is composed of one or more characters, each data segment may be one or more characters. Therefore, according to a property of a character data, the generation module 112 may generate a group of CAPTCHA data comprising characters A-Z (as shown in FIG. 2B). In another embodiment, assuming the first data is an address data, the address data may comprise words or character data (such as city, district, road or street, lane, alley and so on). Therefore, according to a property of the address data, the generation module 112 may generate a group of corresponding CAPTCHA data comprising one or more characters (as shown in FIG. 2C). Note that in the embodiments described at the above, the CAPTCHA data illustrated from FIG. 2A to FIG. 2C are images or pictures (image data). However, in some embodiments, the CAPTCHA data may be in the form of video data or audio data.

For example, but not limited to, in one embodiment, when the operation is a bank transfer operation for a net bank, the data required by the operation may comprise sensitive data such as an account number and an amount transferred. Thus, the generation module 112 may generate 10 CAPTCHA data corresponding to digits 0-9, respectively (as shown in FIG. 2A). In another embodiment, when the required account information of the operation comprises a combination of English characters and numbers, the generation module 112 may generate 38 CAPTCHA data corresponding to the English characters A-Z and the numbers or digits 0-9, respectively (as shown in FIG. 2A and FIG. 2B).

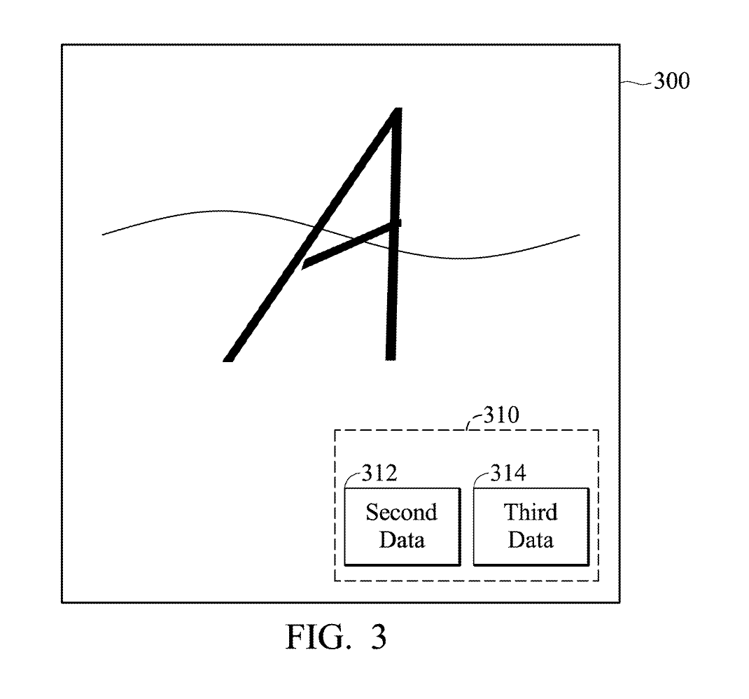

After the generation module 112 generates a group of CAPTCHA data corresponding to the first data set, the encryption module 114 may hide a corresponding encrypted data into each CAPTCHA data, wherein the encrypted data includes information corresponding to the operation, such as identification information of a user or information of an operational step. In some embodiments, the encrypted data may be a watermark, a digital signature, or a specific key generated by an algorithm. Please refer to FIG. 3, wherein FIG. 3 is a schematic diagram illustrating an embodiment of a CAPTCHA data with encrypted data of the invention. As shown in FIG. 3, the CAPTCHA data 300 comprises an encrypted data 310, and the encrypted data 310 is an unseen watermark. The encrypted data 310 further comprises a second data 312 and a third data 314. For example, the second data 312 may represent a corresponding operational step for the encrypted data 310, wherein an operation may comprise multiple operational steps. Namely, encrypted data 310 is generated during a corresponding operational step indicated by the second data 312. The third data 314 may represent identification information of a user of the client 120. Specifically, by inspecting the second data 312 and the third data 314, the step for which the encrypted data 310 is generated and user may be known, and thereby, the user identity and information may be verified.

The CAPTCHA data with encrypted data hidden in it is transmitted to the client 120, and the client 120 may use the CAPTCHA data to perform the operation with the server 110. During the operation, the client 120 may transmit chosen CAPTCHA data to the server 110 for verification.

After that, for example, if an operational step to be performed may be to input the amount of money, wherein the user may input digits of the amount of money by clicking and selecting the CAPTCHA data corresponding to the digit to be inputted. When the user inputs digits of the amount of money, the client 120 may transmit the corresponding CAPTCHA data or its summary information to the server 110 to verify whether the input data is correct and has been successfully transmitted to the server 110.

The decryption module 116 is configured to decrypt the CAPTCHA data with hidden encrypted data transmitted by the client 120. The decryption module 116 may decrypt the encrypted data (e.g. a watermark) from the CAPTCHA data transmitted by client 120, and determine whether the received data is the same as the data originally transmitted according to the content represented by the encrypted data. In some embodiments, the generation module 112 may generate summary information according to information corresponding to the operation. For example, the summary information may be a specific data structure which comprises, for example, the second data 312 and the third data 314 as described previously. In some embodiments, data transmitted by client 120 may be the summary information corresponding to the CAPTCHA data. In this case, the decryption module 116 may decode and extract second data and third data from the summary information transmitted by client 120, and then determine whether the received data is the same as the data originally transmitted according to the content represented by the second data and the third data. The correctness of data transmitted between the server and the client is therefore ensured by the decryption module 116. Detailed methods for CAPTCHA data generation are described hereafter.

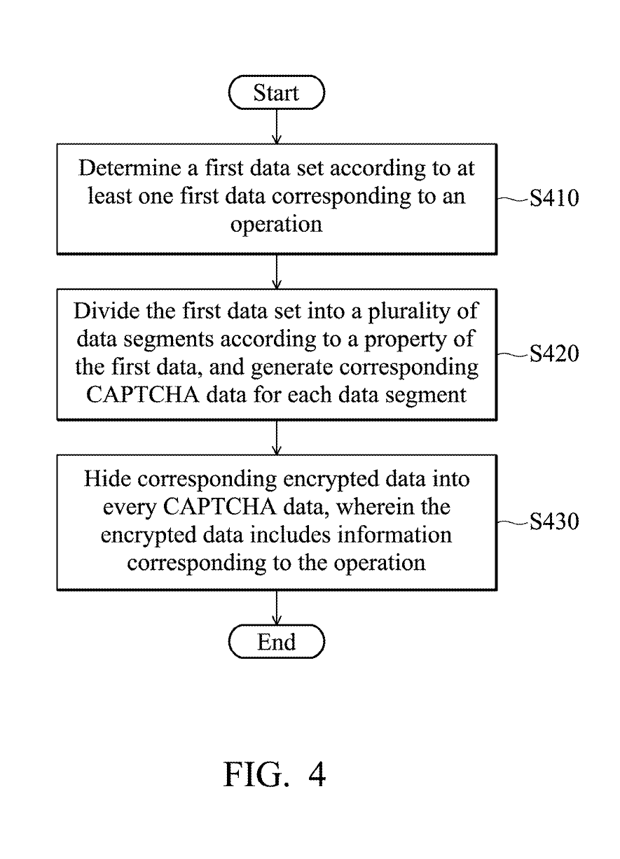

FIG. 4 is a flowchart of an embodiment of a data generation method of the invention. Please refer to FIGS. 1-4. The data generation method of the invention is suitable for use in the server 110 of the data generation system 100 for generating information required when performing an operation. The operation comprises plural operational steps with a fixed execution order. For example, an operation may comprise a first step and a second step, and the second step may be executed only after completion of the first step.

First, in step S410, the generation module 112 determines a first data set according to at least one first data corresponding to an operation. For example, when the first data comprises numeric data, the corresponding first data set may be the numbers 0-9. In another embodiment, when the first data comprises character data, the corresponding first data set may be a set of all possible characters (e.g. A-Z). Then, as shown in step S420, the generation module 112 divides the first data set into a plurality of data segments according to a property of the first data, and generates corresponding CAPTCHA data for each data segment. Similarly, when the first data comprises numeric data which is composed of one or more numbers, each data segment may be one or more numbers. When the first data comprises character data which is composed of one or more characters, each data segment may be one or more characters. For example, but not limited to, when the operation is a bank transfer operation for a net bank, the data required by the operation may comprise sensitive data such as the account number and the amount transferred, thus the generation module 112 may generate 10 CAPTCHA data corresponding to digits 0-9, respectively (as shown in FIG. 2A). In another embodiment, if the account number comprises a combination of the letters of the alphabet and digits, the server 110 may generate 36 CAPTCHA data corresponding to alphabets A-Z and digits 0-9, respectively. Similarly, the CAPTCHA data may be images data, (as shown in FIG. 2A to FIG. 2C) video data or audio data.

After that, in step S430, the encryption module 114 hides corresponding encrypted data into every CAPTCHA data, wherein the encrypted data includes information corresponding to the operation. Similarly, the encrypted data may be a watermark, a digital signature, or a specific key generated by an algorithm. Please refer to FIG. 3, as shown in FIG. 3, the CAPTCHA data 300 comprises an encrypted data 310, and the encrypted data 310 further comprises second data 312 and third data 314. The second data 312 may be used to represent a corresponding operational step for the encrypted data 310, and an operation may comprise multiple operational steps. Specifically, encrypted data 310 is generated at the corresponding operational step (which is represented by second data 312). The third data 314 may represent identification information of a user of the client 120.

The CAPTCHA data with encrypted data hidden in it is transmitted to the client 120, and the client 120 may use the CAPTCHA data to perform the operation with the server 110. During the operation, the client 120 may transmit chosen CAPTCHA data to the server 110 for verification. The client 120 may transmit the corresponding CAPTCHA data or its summary information to the server 110 to verify whether data has been correctly transmitted to the server 110.

After that, when the server 110 receives data sent by the client 120, the server 110 may check whether the encrypted data in the CAPTCHA data transmitted is correct, in order to ensure that the data has been transmitted correctly.

An embodiment is described below to help explain the data processing method for the present invention in more detail, but is not limited thereto. In one embodiment, when the operation is a bank transfer operation for a net bank, the “account number” data and the “amount transferred” data will affect the outcome of the bank transfer operation. Therefore, the account numeric data and amount transferred data may be defined as sensitive data of the bank transfer operation. The corresponding data set for the “account number” data and the “amount transferred” data may be the numbers “0” to “9” and the characters “A” to “Z”. For example, the “account number” data may be “A123456” and the “amount transferred” data may be “1000”. Therefore, as described above, the numbers “0” to “9” and the characters “A” to “Z” are the possible data set. Therefore, according to the CAPTCHA data generation methods of the present invention, the generation module 112 in the server 110 generates corresponding CAPTCHA data of numbers “0” to “9” and characters “A” to “Z” (as shown in FIG. 2A to FIG. 2B). Then, the encryption module 114 in the server 110 hides a corresponding encrypted data into every CAPTCHA data. Finally, the CAPTCHA data with encrypted data may be transmitted to the client 120, and the CAPTCHA data with encrypted data may be used to process the bank transfer operation.

In summary, according to the data generation system and related data generation method of the invention, it is possible to generate a group of CAPTCHA data according to all possible data sets corresponding to sensitive data of a user in an operation to be performed, and then encrypt the group of CAPTCHA data with encrypted data (such as a watermark) corresponding to the operation, thereby enhancing transaction processes. By using the CAPTCHA data technique for transaction processes instead of computer-based texts, which may easily be revised by malicious programs (e.g. viruses or wooden horse programs), at both the client and the server sides, transaction processes are better protected in comparison to the transaction process using computer-based texts. Additionally, the CAPTCHA data generation technique ensures that important information is not lost or stolen during the transmission process, thereby increasing security when performing operations.

Data generation methods and data generation systems thereof, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A data generation method for CAPTCHA (Completely Automated Public Test to tell Computers and Humans Apart) data generation for a server, comprising:
determining a first data set according to at least one first data corresponding to an operation, wherein the first data represents sensitive data corresponding to the operation; and
generating a group of CAPTCHA data corresponding to the first data set according to the first data.

2. The data generation method as claimed in claim 1, further comprising:
hiding corresponding encrypted data into each CAPTCHA data, wherein the encrypted data includes information corresponding to the operation.

3. The data generation method as claimed in claim 2, wherein the group of CAPTCHA data with the encrypted data is transmitted to a client, which is used by the client with the encrypted data to perform the operation with the server.

4. The data generation method as claimed in claim 2, further comprising:
generating summary information according to the information corresponding to the operation.

5. The data generation method as claimed in claim 4, wherein the operation comprises a plurality of operational steps, and the information corresponding to the operation included in the encrypted data comprises second data, wherein the second data represents a corresponding operational step for the encrypted data.

6. The data generation method as claimed in claim 5, wherein the information corresponding to the operation included in the encrypted data comprises third data, wherein the third data represents identification information of a user of the client.

7. The data generation method as claimed in claim 2, wherein the encrypted data is a watermark.

8. The data generation method as claimed in claim 1, wherein the method of generating the group of CAPTCHA data corresponding to the first data set according to the first data further comprises:
dividing the first data set into a plurality of data segments according to a property of the first data; and
generating a corresponding CAPTCHA data for each data segment.

9. The data generation method as claimed in claim 8, wherein the first data comprises numeric data, and each data segment is one or a plurality of numbers.

10. The data generation method as claimed in claim 8, wherein the first data comprises character data, and each data segment is one or a plurality of characters.

11. The data generation method as claimed in claim 1, wherein each CAPTCHA data comprises image data, video data, or audio data.

12. A data generation system for CAPTCHA (Completely Automated Public Test to tell Computers and Humans Apart) data generation, comprising:
a server determining a first data set according to at least one first data corresponding to an operation, and generating a group of CAPTCHA data corresponding to the first data set according to the first data, wherein the first data represents sensitive data corresponding to the operation.

13. The data generation system as claimed in claim 12, wherein the server further comprises a generation module, and the generation module is configured to determine the first data set according to the first data, and generate the group of CAPTCHA data corresponding to the first data set.

14. The data generation system as claimed in claim 13, wherein the server further comprises an encryption module, and the encryption module is configured to hide corresponding encrypted data into each CAPTCHA data, wherein the encrypted data includes information corresponding to the operation.

15. The data generation system as claimed in claim 14, wherein the server transmits the group of CAPTCHA data with the encrypted data to a client, which is used by the client with the encrypted data to perform the operation with the server.

16. The data generation system as claimed in claim 14, wherein the generation module generates summary information according to the information corresponding to the operation.

17. The data generation system as claimed in claim 16, wherein the operation comprises a plurality of operational steps, and the information corresponding to the operation included in the encrypted data comprises second data, wherein the second data represents a corresponding operational step for the encrypted data.

18. The data generation system as claimed in claim 17, wherein the information corresponding to the operation included in the encrypted data comprises a third data, wherein the third data represents identification information of a user of the client.

19. The data generation system as claimed in claim 14, wherein the encrypted data is a watermark.

20. The data generation system as claimed in claim 12, wherein the generation module divides the first data set into a plurality of data segments according to a property of the first data, and generates a corresponding CAPTCHA data for each data segment.

21. The data generation system as claimed in claim 20, wherein the first data comprises numeric data, and each data segment is a number.

22. The data generation system as claimed in claim 20, wherein the first data comprises character data, and each data segment is one or a plurality of characters.

23. The data generation system as claimed in claim 12, wherein each CAPTCHA data comprises image data, video data, or audio data.

24. A non-transitory machine-readable storage medium comprising a computer program, which, when executed, causes a device to perform a data generation method for CAPTCHA (Completely Automated Public Test to tell Computers and Humans Apart) data, comprising:
a first program code for determining a first data set according to at least one first data corresponding to an operation, wherein the first data represents sensitive data corresponding to the operation;
a second program code for generating a group of CAPTCHA data corresponding to the first data set according to the first data; and
a third program code for hiding corresponding encrypted data into each CAPTCHA data in the group of CAPTCHA data, wherein the encrypted data includes information corresponding to the operation.
